(19) United States
(12) Patent Application Publication
(10) Pub. No.: US 2025/0004169 A1
(43) Pub. Date: Jan. 2, 2025

(54) METASURFACE OPTICAL MODE FILTERING

(71) Applicant: Quantinuum LLC, Broomfield, CO (US)

(72) Inventors: Adam Jay OLLANIK, Boulder, CO (US); Rezlind BUSHATI, Rockville, MD (US); David MILLER, Broomfield, CO (US); David M. GAUDIOSI, Loveland, CO (US); Justin SCHULTZ, Boulder, CO (US)

(21) Appl. No.: 18/753,172

(22) Filed: Jun. 25, 2024

Related U.S. Application Data
(60) Provisional application No. 63/524,122, filed on Jun. 29, 2023.
(60) Provisional application No. 63/579,608, filed on Aug. 30, 2023.

(51) Int. Cl. G02B 1/00; G02B 5/20

(52) U.S. Cl. CPC G02B 1/002; G02B 5/20

(57) ABSTRACT

An optical system includes an optical mode filter comprising a metasurface optical element. The metasurface optical element is configured to, in response to an optical beam being incident thereon, emit a selected mode beam with first propagation characteristics and one or more unselected mode beams with respective second propagation characteristic. The first propagation characteristics differ from the respective second propagation characteristics such that a majority of the optical power of the selected mode beam is caused to be incident on at least one of a downstream optical element or a target location and a majority of the optical power of the one or more unselected mode beams is caused to be not incident on the at least one of the downstream optical element or the target location.

### CROSS-REFERENCE TO RELATED APPLICATIONS

This application claims priority to U.S. Application No. 63/579,608 filed Aug. 30, 2023, and to U.S. Application No. 63/524,122, filed Jun. 29, 2023, the contents of which are incorporated herein by reference in their entireties.

### TECHNICAL FIELD

Various embodiments relate to optical mode filtering. An example embodiment relates to a metasurface optical element configured for optical mode filtering.

### BACKGROUND

When an optical beam is propagated through an optical system, the optical beam may include multiple optical modes. However, it may be desired to use a particular mode of the optical beam to perform a task (e.g., interact with trapped ions, and/or the like). Through applied effort, ingenuity, and innovation many deficiencies of prior optical beam delivery systems have been solved by developing solutions that are structured in accordance with the embodiments of the present invention, many examples of which are described in detail herein.

### BRIEF SUMMARY OF EXAMPLE EMBODIMENTS

Example embodiments provide optical systems, systems and/or assemblies including optical systems, and/or the like that use metasurface optical elements to spatially filter modes of an optical beam. For example, an example embodiment provides a quantum charge-coupled device (QCCD)-based quantum computer including an optical system that spatially filters modes of an optical beam using a metasurface optical element. In an example embodiment, the metasurface optical element is configured to control optical properties of a selected mode beam.

In various embodiments, the optical system includes an array of optical beams, respective metasurface optical elements for spatially filtering modes of respective optical beams of the array of optical beams. In various embodiments, the optical system includes various optical elements as appropriate for the application. For example, in an example embodiment, an array of metasurfaces optical elements receives a plurality of optical beams and provides an array of property-controlled selected mode beams where the optical properties of each selected mode beam are controlled and/or conditioned independently by a respective metasurface optical element. In an example embodiment, the optical system further includes a relay component configured to relay the plurality of property-controlled selected model beams to respective target locations of an array of target locations. For example, the relay component is configured to provide a respective property-controlled selected mode beam to a respective target location at an appropriate incident angle for the respective target location.

According to a first aspect, an optical system is provided. In an example embodiment, the optical system includes an optical mode filter comprising a metasurface optical element having an upstream surface and a downstream surface. The metasurface optical element is configured to, in response to an optical beam being incident on the upstream surface, emit a selected mode beam along a selected mode axis and emit at least one unselected mode beam along an unselected mode axis. The selected mode axis and the unselected mode axis forming different angles with respect to an optical axis of the metasurface optical element axis.

In an example embodiment, a downstream component of the optical system is aligned with the selected mode axis.

In an example embodiment, one of a photon absorber, a photon blocker, a photon deflector, or a photodetector is aligned with the unselected mode axis.

In an example embodiment, the selected mode beam is provided to a target location of the optical system.

In an example embodiment, the metasurface optical element is configured to control one or more optical properties of the selected mode beam.

In an example embodiment, the one or more optical properties include at least one of polarization, wavelength, focusing, beam waist, phase, beam profile, or intensity.

In an example embodiment, the system further includes a beam source configured to generate and provide the optical beam.

In an example embodiment, the beam source comprises at least one of an optical fiber, waveguide, or laser and the optical beam is a laser beam.

In an example embodiment, the beam source is part of a one-dimensional or two-dimensional array of beam sources and the metasurface optical element is part of one-dimensional or two-dimensional array of metasurface optical elements.

In an example embodiment, a difference in a direction defined by the selected mode axis and a direction defined by the unselected mode axis is used to spatially filter the selected mode beam from the unselected mode beam.

In an example embodiment, the optical beam comprises one or more Gaussian, Laguerre Gaussian, Hermite Gaussian, Bessel beam, or Airy beam optical modes.

In an example embodiment, the selected mode beam is propagated to a target location and the unselected mode beam is propagated to a location that is not the target location.

In an example embodiment, the metasurface optical element is configured to act on the selected mode beam with a first order interaction.

According to another aspect, an optical system is provided. In an example embodiment, the optical system includes one or more beam sources; a target apparatus defining one or more target locations; and one or more optical mode filters. Each of the optical mode filters includes a respective metasurface optical element having an upstream surface and a downstream surface. The respective metasurface optical element is configured to, in response to an optical beam being incident on the upstream surface, emit a selected mode beam along a selected mode axis and emit at least one unselected mode beam along an unselected mode axis. The selected mode axis and the unselected mode axis forming different angles with respect to an optical axis of the metasurface optical element axis. The one or more beam sources are configured to provide respective optical beams to the one or more optical mode filters and the selected mode beam is provided to a respective target location of the one or more target locations.

In an example embodiment, the optical system further includes at least one of a photon absorber, a photon blocker, a photon deflector, or a photodetector, wherein the at least one of the photon absorber, a photon blocker, a photon deflector, or the photodetector is aligned with the unselected mode axis.

In an example embodiment, the metasurface optical element is configured to control one or more optical properties of the selected mode beam.

In an example embodiment, the one or more optical properties include at least one of polarization, wavelength, focusing, beam waist, phase, beam profile, or intensity.

In an example embodiment, the optical system is a beam delivery system of a quantum charge-coupled device (QCCD)-based quantum computer.

In an example embodiment, each of the one or more beam sources comprises at least one of an optical fiber, waveguide, or laser and the optical beam is a laser beam.

In an example embodiment, the metasurface optical element is configured to act on the selected mode beam with a first order interaction.

According to another aspect, an optical system is provided. In an example embodiment, the optical system includes an optical mode filter comprising a metasurface optical element. The metasurface optical element is configured to, in response to an optical beam being incident thereon, emit a selected mode beam with first propagation characteristics and one or more unselected mode beams with respective second propagation characteristics. The first propagation characteristics differ from the respective second propagation characteristics such that a majority of the optical power of the selected mode beam is caused to be incident on at least one of a downstream optical element or a target location and a majority of the optical power of the one or more unselected mode beams is caused to be not incident on the at least one of the downstream optical element or the target location.

In an example embodiment, differences in the first propagation characteristics and the second propagation characteristics are used to spatially filter the selected mode beam from the one or more unselected mode beams.

In an example embodiment, the optical system further includes an optical block defining an aperture, wherein the first propagation characteristics are configured to cause the selected mode beam to propagate through the aperture and the second propagation characteristics are configured to cause the one or more unselected mode beams to be incident on the optical block.

In an example embodiment, the first propagation characteristics corresponding focusing of the selected mode beam on the aperture.

In an example embodiment, the first propagation characteristics correspond to the selected mode beam having an angle of divergence smaller than a threshold angle and the second propagation characteristics correspond to the one or more unselected mode beams having respective angles of divergence that are each larger than the threshold angle.

In an example embodiment, the first propagation characteristics correspond to the selected mode beam being a collimated beam and the second propagation characteristics corresponding to the one or more unselected mode beams being diverging beams.

In an example embodiment, the optical system further includes a lens configured to project the selected mode beam and the one or more unselected mode beams onto a Fourier plane; and an optical block defining a pin hole disposed at the Fourier plane, wherein the first propagation characteristics correspond to the selected mode beam propagating through the pin hole and the second propagation characteristics corresponding to the one or more unselected mode beams being substantially incident on the optical block.

In an example embodiment, the optical system further includes a lens configured to project the selected mode beam and the one or more unselected mode beams onto a Fourier plane; and an optical block disposed at the Fourier plane, wherein the first propagation characteristics correspond to the selected mode beam propagating around the optical block and the second propagation characteristics corresponding to the one or more unselected mode beams being substantially incident on the optical block.

In an example embodiment, the first propagation characteristics correspond to the selected mode beam propagating along a selected mode axis and the second propagation characteristics correspond to the one or more unselected mode beams propagating along respective unselected mode axes, the selected mode axis and the respective unselected mode axes forming different angles with respect to an optical axis of the metasurface optical element.

In an example embodiment, one of a photon absorber, a photon blocker, a photon deflector, or a photodetector is aligned with at least one of the respective unselected mode axes.

In an example embodiment, differences in a direction defined by the selected mode axis and respective directions defined by the respective unselected mode axes are used to spatially filter the selected mode beam from the one or more unselected mode beams.

In an example embodiment, the metasurface optical element is configured to control one or more optical properties of the selected mode beam.

In an example embodiment, the one or more optical properties include at least one of polarization, wavelength, focusing, beam waist, phase, beam profile, or intensity.

In an example embodiment, the optical system further includes a beam source configured to generate and provide the optical beam.

In an example embodiment, the beam source comprises at least one of an optical fiber, waveguide, or laser and the optical beam is a laser beam.

In an example embodiment, the beam source is part of a one-dimensional or two-dimensional array of beam sources and the metasurface optical element is part of one-dimensional or two-dimensional array of metasurface optical elements.

In an example embodiment, the optical beam comprises one or more Gaussian, Laguerre Gaussian, Hermite Gaussian, Bessel beam, or Airy beam optical modes.

In an example embodiment, the selected mode beam is propagated to a target location and the one or more unselected mode beams are propagated to one or more respective locations that are not the target location.

In an example embodiment, the metasurface optical element is configured to act on the selected mode beam with a first order interaction.

According to another aspect, a system, such as a QCCD-based quantum computer, for example, is provided that includes an optical system disclosed herein.

In an example embodiment, the system further comprises one or more beam sources and/or a target apparatus defining one or more target locations.

In an example embodiment, the optical system of the system is a beam delivery system configured to provide respective beams to the one or more target locations for performing particle interaction.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic diagram of an example optical system, according to an example embodiment.

FIG. 2A provides a schematic cross-sectional diagram of a portion of an example optical system, according to example embodiments.

FIG. 2B shows an experimentally captured image of s a selected mode and a plurality of non-selected modes that were spatially separated by an optical mode filter of an example embodiment.

FIGS. 3A and 3B provide a top view and a side view, respectively, of an example optical system, according to an example embodiment.

FIGS. 4A and 4B provide a top view and a side view, respectively, of an example optical system, according to another example embodiment.

FIG. 5 provides a schematic cross-sectional diagram of a portion of another example optical system configured for performing optical mode filtering, according to an example embodiment.

FIG. 6A provides a schematic cross-sectional diagram of a portion of a third example optical system configured for performing optical mode filtering, according to an example embodiment.

FIG. 6B provides a schematic cross-sectional diagram of a portion of a fourth example optical system configured for performing optical mode filtering, according to an example embodiment.

FIG. 7 is a schematic diagram of an example quantum computing system that includes an optical system, according to an example embodiment.

FIG. 8 provides a schematic diagram of an example controller of a quantum computer configured to control operation of various components of a quantum processor, according to various embodiments.

FIG. 9 provides a schematic diagram of an example computing entity of a quantum computing system that may be used in accordance with an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally,” “substantially,” and “approximately” refer to within engineering and/or manufacturing tolerances and/or within user measurement capabilities, unless otherwise indicated. Like numbers refer to like elements throughout.

Example embodiments provide optical systems, systems and/or assemblies including optical systems, and/or the like that use metasurface optical elements to spatially filter optical modes of an optical beam. In various embodiments, the optical modes of an optical beam may be Gaussian optical modes, Laguerre Gaussian, Hermite Gaussian, Bessel beam, and/or Airy beam optical modes, and/or the optical modes. For example, an example embodiment provides a quantum charge-coupled device (QCCD)-based quantum computer including an optical system that spatially filters modes of an optical beam using a metasurface optical element. In an example embodiment, the metasurface optical element is configured to control optical properties of a selected mode beam.

In various embodiments, the optical system includes an array of optical beams, respective metasurface optical elements for spatially filtering modes of respective optical beams of the array of optical beams. In various embodiments, the optical system includes various optical elements as appropriate for the application. For example, in an example embodiment, an array of metasurfaces optical elements receives a plurality of optical beams and provides an array of property-controlled selected mode beams where the optical properties of each selected mode beam are controlled and/or conditioned independently by a respective metasurface optical element. In an example embodiment, the optical system further includes a relay component configured to relay the plurality of property-controlled selected model beams to respective target locations of an array of target locations. For example, the relay component is configured to provide a respective property-controlled selected mode beam to a respective target location at an appropriate incident angle for the respective target location.

In various optical systems, multiple optical modes may propagate through various portions of the optical system. The optical system may be configured to provide one or more optical beams or pulses for a particular interaction. For example, the optical system may be configured to provide optical beams or pulses (e.g., laser beams or pulses) for interaction with one or more particles (e.g., atoms, ions, molecules, quantum dots, and/or the like). The desired interaction may be performed with a beam of a particular beam profile. For example, it may be desired to have a first order Gaussian beam. In another example, it may be desired to have a higher order beam. Therefore, it may be desired to provide an optical beam or pulses having a particular optical mode. Thus, technical problems exist regarding how to filter an optical beam to provide an optical beam having only a desired optical mode and/or to remove undesired optical modes from the optical beam. To provide an optical beam of the desired beam profile or optical mode, the other optical modes.

Various embodiments provide technical solutions to these technical problems. In various embodiments, an optical mode filter and/or an optical system including an optical mode filter is provided. In various embodiments, the optical mode filter includes a metasurface optical element configured to provide a selected mode beam having first propagation characteristics and one or more unselected mode beams having respective second propagation characteristics where the first propagation characteristics and the respective second propagation characteristics are configured to spatially separate optical modes of an optical beam incident thereon. For example, the first propagation characteristics and the respective second propagation characteristics are configured to enable spatial filtering to be used to prevent and/or minimize the optical power of the unselected mode beams that reach the target location. As the different optical modes of the optical beam are spatially separated by the optical mode filter, one or more desired optical modes may be guided downstream through the optical system and undesired optical modes can be removed from the optical beam. The desired optical mode may be guided to a target location to, for example, interact with one or more particles. Thus, various embodiments provide technical improvements to the fields of optical mode filtering, optical systems such as optical beam delivery systems, systems that include optical systems, and/or the like.

### Example Optical System

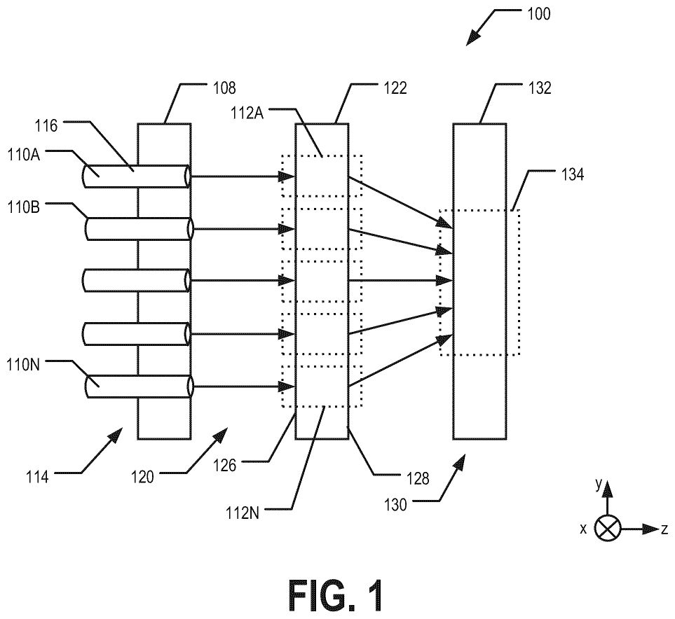

Various embodiments provide an optical system including one or more optical mode filters. FIG. 1 provides a schematic diagram of an example optical system 100. In various embodiments, an optical system 100 comprises optical components 120 and one or more target apparatuses 130. In various embodiments, the one or more optical components 120 include one or more optical mode filters 112 (e.g., 112A, . . . , 112N). In an example embodiment, the one or more optical mode filters 112 are formed and/or disposed on one or more substrates 122. In various embodiments, a substrate 122 is formed of glass or another material that is transparent to light characterized by wavelengths corresponding to the optical beams is configured to provide, guide, and/or condition. In various embodiments, one optical mode filter 112, a plurality of optical mode filters, or a one or two-dimensional array of optical mode filters may be formed on and/or in the substrate 122.

In various embodiments, an optical mode filter 112 is configured and/or designed such that the optical axis of a selected mode is different from the optical axis of an incident beam, the incident beam being incident on the optical mode filter 112 and the selected mode being a provided by the optical mode filter 112 as a result of the incident beam being incident thereon. For example, the optical mode filter 112 imparts a one-dimensional phase gradient on the selected mode such that a non-zero angle is formed between an optical axis of the selected mode and the optical axis of the incident beam.

In various embodiments, one or more beam sources 110 (e.g., 110A, 110B, 110N) are configured to provide one or more optical beams to the one or more optical components 120. For example, in the illustrated embodiment of FIG. 1, the one or more beam sources 110 includes a v-groove array 114 formed on a beam source substrate 108 and having a plurality of optical fibers secured into respective v-grooves of the v-groove array 114. In various embodiments, various other beam sources may be used (e.g., waveguides, optical fiber bundles, free space optics, lasers, and/or the like). Each of the beam sources 110 (e.g., optical fiber 116, a waveguide, or free space/bulk optics) provides a respective optical beam such that the respective optical beam is incident on the upstream surface of a respective optical component of the one or more optical components 120. In an example embodiment, the beam source substrate 108 is coupled and/or secured to a substrate 122.

For example, in the illustrated embodiment, an optical fiber 116 of a first beam source 110A provides a first optical beam that is incident on the upstream surface 126 of an optical mode filter 112A. The optical mode filter 112A spatially separates the optical modes of the first optical beam and the spatially separated optical modes propagate out through the downstream surface 128 of the optical mode filter 112A. For example, the optical mode filter 112A causes a selected mode beam to have first propagation characteristics and one or more unselected mode beams to have respective second propagation characteristics such that the differences between the first propagation characteristics and the respective second propagation characteristics enable spatial filtering of the selected mode beam and/or the unselected mode beams. A selected and/or desired optical mode of the first optical beam is provided to a respective target location 134. For example, the selected and/or desired optical mode of the first optical beam may be provided to the respective target location 134 to interact with one or more particles confined at the target location 134.

In various embodiments, the optical system 100 is configured to provide one or more optical beams to respective target locations 134 of a target apparatus 130. For example, the target apparatus 130 may define one or more target locations 134. In various embodiments, a respective target location 134 is configured for an optical mode-filtered optical beam to be incident thereat. In various embodiments, the target apparatus 130 is formed on an apparatus substrate 132.

In an example embodiment, the upstream surface 126 and the downstream surface 128 are the same surface of the optical mode filter 112A. For example, similar to a conventional mirror, a single surface of the optical mode filter 112A may be configured to have an optical beam incident thereon (e.g., as an upstream surface 126) and configured to provide the spatially separated optical mode beams (e.g., as a downstream surface 128).

Various other optical systems may include an optical mode filter and may include various optical components, beam sources, and/or target apparatuses as appropriate for the application.

### Example Optical Mode Filter

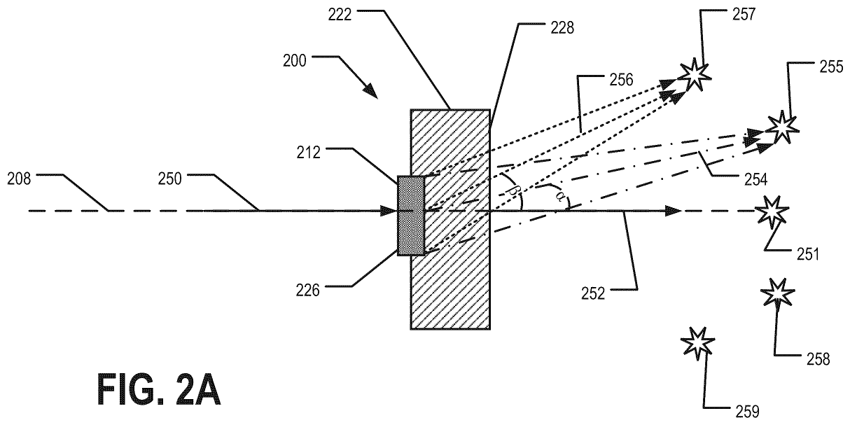

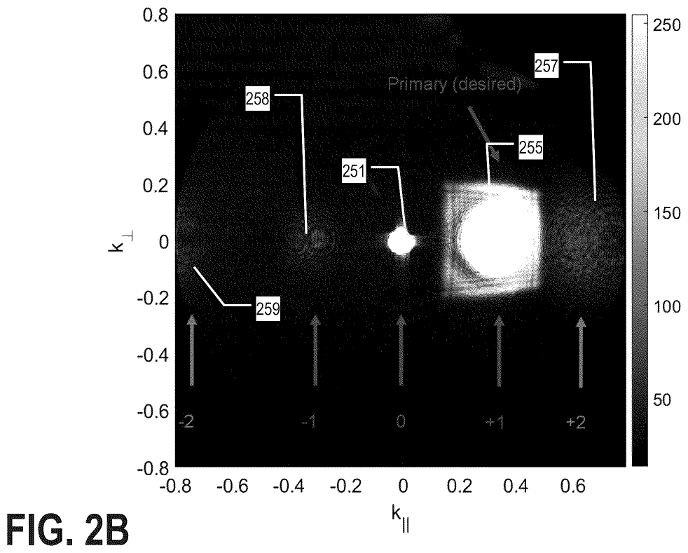

FIG. 2A illustrates an example optical mode filter 200. The optical mode filter 200 includes a metasurface optical element 212 formed on or in a substrate 222. In various embodiments, the one or more optical mode filter 200 is configured to spatially separate optical modes of an optical beam incident thereon. In various embodiments, the optical mode filter 200 is further configured to condition the optical beam. For example, the optical mode filter 200 may act as a waveplate, lens, aspheric collimator, and/or the like. In various embodiments, an optical mode filter 200 is configured to control and/or condition optical properties of a respective optical beam (e.g., laser beam, series of laser pulses, microwave beam, and/or the like). For example, in an example embodiment, an optical mode filter 200 is configured to control and/or condition the polarization, wavelength, focusing, beam waist, wavelength, phase, direction of propagation, beam profile, intensity, and/or other optical property of an optical beam incident thereon.

The optical mode filter 200 is configured to, responsive to an optical beam being incident thereon, causes a selected mode beam to be provided with first propagation characteristics and one or more unselected mode beams to be provided with respective second propagation characteristics. The differences between the first propagation characteristics and the respective second propagation characteristics enable spatial filtering of the selected mode beam and/or the unselected mode beams. In various embodiments, the propagation characteristics of a respective include a direction of propagation of the respective beam, a divergence angle of the respective beam, a focal location of the respective beam, and/or other observables that describe how the respective beam propagates downstream of the metasurface optical element 212 and/or the optical mode filter 200.

FIG. 2A illustrates an incident beam axis 250 of an optical beam incident on the upstream surface 226 of a metasurface optical element 212 of an optical mode filter 200. The incident beam axis 250 is parallel to an optical axis 208 of the optical mode filter 200. The zeroth mode beam axis 252 illustrates the beam axis of a mode of the optical beam that passed through the respective metasurface optical element 212 without being changed and/or affected by the metasurface optical element 212. For example, the zeroth mode is a zero order and/or unaffected mode of the optical beam. For example, the zeroth mode beam axis 252 is aligned, parallel, and/or colinear with the incident beam axis 250.

The first mode beam axis 254 illustrates the beam axis of a first mode beam 255 of the optical beam exiting the downstream surface 228 of the optical mode filter 200. For example, the first mode may be a first order optical beam that was modified in accordance with a first order effect of the metasurface optical element 212. For example, the first mode beam axis 254 is the beam axis of a first mode beam 255 of the optical beam. The first mode beam 255 is an optical beam that includes of a portion of the incident optical beam that is in a first optical mode. The first mode beam axis 254 forms a first angle α with the optical axis 208 of the optical mode filter 200. The first angle α is non-zero. For example, the first angle α is an angle between five and eighty degrees, in an example embodiment. In various embodiments, the first mode beam 255 has had one or more optical properties thereof controlled by the metasurface optical element 212 of the optical mode filter 200.

The second mode beam axis 256 illustrates the beam axis of a second mode beam 257. For example, the second mode beam 257 of the optical beam may be a second order optical beam that was modified in accordance with a second order effect of the metasurface optical element 212. For example, second mode beam axis 256 is the beam axis of a second mode beam 257. The second mode beam 257 is an optical beam that includes of a portion of the incident optical beam that is in a second optical mode. The second mode beam axis 256 forms a second angle β with the optical axis 208 of the optical mode filter 200. The second angle β is non-zero. For example, in various embodiments, the second angle β is different from the first angle α. In an example embodiment, the second angle β is larger than the first angle α (e.g., twice the first angle α, in an example embodiment). Various other non-zero order beams form respective angles with the optical axis 208 that are non-zero.

For example, FIG. 2B shows an experimentally captured image where the x- and y-axes represent angles at which light leaves the downstream surface 228 of the metasurface optical element 212. For example, the experimentally captured image shown in FIG. 2B is shown in k-space and/or via Fourier imaging. A zeroth mode and/or unaffected mode beam 251 has a zeroth mode beam axis 252 that is aligned, parallel, and/or colinear with the incident beam axis 250.

The selected and/or first mode beam 255 leaves the downstream surface 228 of the metasurface optical element 212 at a different angle than the zeroth and/or unaffected mode beam 251. In general, the selected and/or first mode beam 255 leaves the downstream surface 228 of the metasurface optical element 212 at a different angle than the non-selected mode beams (e.g., the zeroth and/or unaffected mode beam 251, second mode beam 257, negative first mode beam 258, and negative second mode beam 259). Also, as shown in FIG. 2B, in various embodiments, the intensity of the unselected mode beams (e.g., the zeroth and/or unaffected mode beam 251, second mode beam 257, negative first mode beam 258, and negative second mode beam 259) may be dampened by the metasurface optical element 212 and/or caused to have a substantially lower intensity than the selected mode beam 255.

In various embodiments, the differences in the respective angles between the optical axis 208 of the optical mode filter and a respective one of the zeroth mode beam axis 252, the first mode beam axis 254, and the second mode beam axis 256 (and subsequent other mode beam axes) enables spatial filtering of the optical beam provided to the respective target location of the target apparatus. For example, spatial filtering may be used such that a desired mode (e.g., the first mode beam 255) is relayed to the respective target location (e.g., one or more optical components, free space optics, optical fibers, waveguides, and/or the like) and the other optical modes of the optical beam (e.g., the zeroth mode, second mode, and any additional modes) are not relayed to the respective target location.

For example, a selected mode (e.g., the first mode beam 255) is emitted from and/or leaves the downstream surface 228 of the optical mode filter 200 with first propagation characteristics. The first propagation characteristics correspond to the selected mode beam propagating along a selected mode axis (e.g., the first mode beam axis 254). One or more unselected modes (e.g., the zeroth mode optical beam, second mode beam 257) are emitted from and/or leaves the downstream surface 228 of the optical mode filter 200 with respective second propagation characteristics. The respective second propagation characteristics correspond to the respective unselected mode beams propagating along respective unselected mode axes (e.g., the zeroth mode beam axis 252, second mode beam axis 256, and/or the like) that are not parallel and not colinear with the selected mode axis. For example, one or more downstream components of the optical system (e.g., additional optical elements, a target location, and/or the like) are aligned with the selected mode axis.

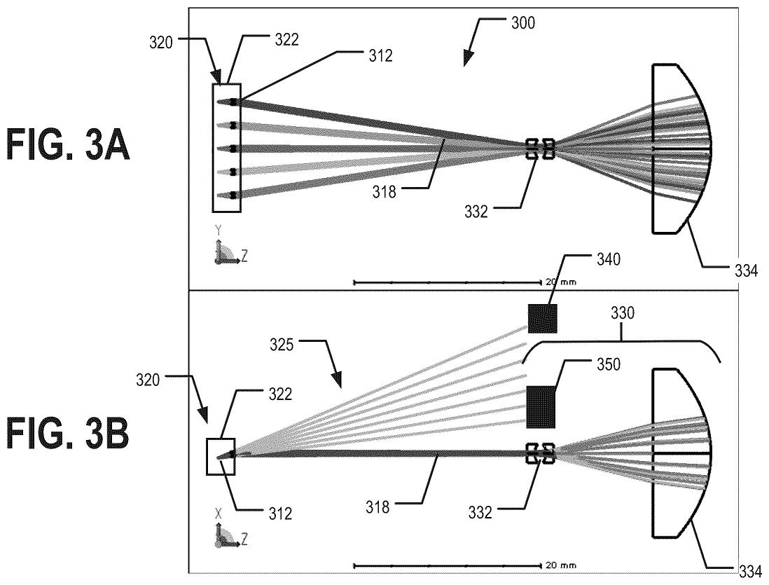

FIG. 3A is a top view of an example optical system 300 and FIG. 3B is a side view of the example optical system 300. In the illustrated embodiment, the optical mode filters 320 are similar to the optical mode filter illustrated in FIG. 2A. For example, each optical mode filter 320 includes a metasurface optical element 312 formed on and/or in substrate 322. The metasurface optical element 312 is configured to spatially separate optical modes of an optical beam incident thereon. The optical system 300 includes additional optical elements 330 configured to direct the respective selected mode beams 318 toward respective target locations. For example, the additional optical include a pair of negative lenses 332 and a focusing element 334.

As shown in FIG. 3B, the respective optical beams provided by the downstream surface of the respective optical mode filters 320 are spatially filtered so that the respective selected mode beams 318 (e.g., which interacts with the metasurface optical element in a first order interaction, in an example embodiment) are incident on the pair of negative lenses 332 and the unselected mode beams 325 are not. For example, the unselected mode beams 325 are deflected by the respective optical mode filter 320 such that the unselected mode beams 325 are not relayed to the respective target locations.

In various embodiments, a photodetector or photon absorber, a photon blocker, or a photon deflector is aligned with one or more unselected mode axes. In an example embodiment, one or more of the non-selected modes of the optical beam may be provided to a photodetector and/or power meter 340 such that the intensity of the optical beam may be monitored and/or measured. In an example embodiment, one or more photon absorbers 350 are positioned to absorb one or more of the non-selected modes of the optical beam. In various embodiments, one or more photon absorbers 350 of the illustrated embodiment are replaced with a photon blocker(s) or photon deflector(s). For example, the photon absorber(s) 350, photon deflector(s), and/or photon blocker(s) may be configured to prevent photons of one or more of the unselected modes of the optical beam from reaching any of the target locations.

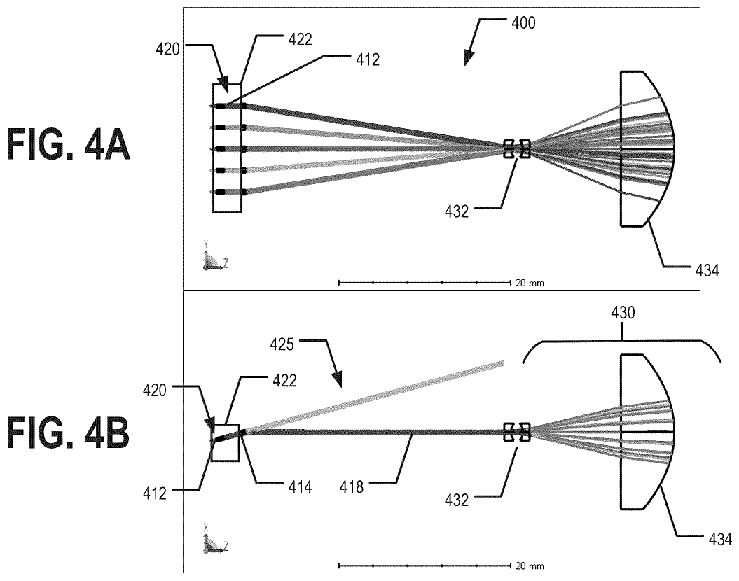

FIG. 4A is a top view of an example optical system 400 and FIG. 4B is a side view of the example optical system 400. In the illustrated embodiment, the optical mode filters 420 are similar to the to the optical mode filters 200 with the addition of an aspheric collimator 414 formed and/or disposed on a downstream surface of the substrate 422. For example, each optical mode filter 420 consists of a metasurface optical element 412 and an aspheric collimator 414. The additional optical elements 430 is similar to the additional optical elements 330 in that it comprises a pair of negative lenses 432 and a focusing element 434.

As shown in FIG. 4B, the respective optical beams provided by the downstream surface of the optical mode filters 420 are spatially filtered so that the respective selected mode beams 418 are incident on the pair of negative lenses 432 and the unselected mode beams 425 are not. For example, the unselected mode beams 525) are deflected by the respective optical mode filter 420 such that the unselected mode beams 425 are not relayed to the respective target locations.

In FIG. 3B, the unselected mode beams 325 form a fan or sequence of unselected mode beams. In FIG. 4B, the unselected mode beams 425 form a single unselected mode beam as a result of the inclusion of the respective aspheric collimators 414 in the respective optical mode filters 420.

In various embodiments, one or more of the unselected mode beams 325, 425 are provided to a photodiode, power meter, or other optical device that may be used to monitor alignment, power output, power fluctuations, phase fluctuations, wavelength fluctuations, noise, and/or the like of the optical beams and/or the optical system 300, 400. In various embodiments, one or more of the unselected mode beams 325, 425 are absorbed by a photon absorber, blocked by a photon blocker, and/or deflected by a photon deflector. For example, a photodetector (e.g., photodiode, power meter, and/or the like) or a photon absorber, photon blocker, or photon deflector may be aligned with one or more unselected mode axis of one or more unselected mode beams.

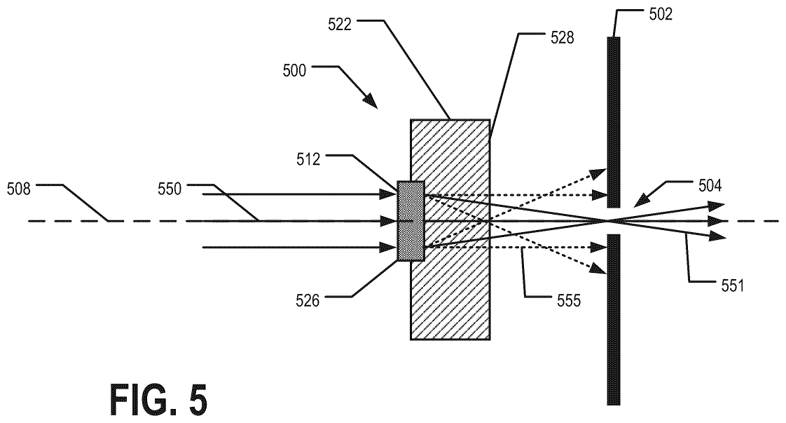

FIG. 5 illustrates another example optical mode filter 500 that may be used in an optical system 100, 300, 400. The optical mode filter 500 includes a metasurface optical element 512 formed on or in a substrate 522. In various embodiments, the one or more optical mode filter 500 is configured to spatially separate optical modes of an optical beam incident thereon. For example, the optical mode filter 500 is configured to filter an optical beam such that a selected mode beam 551 passes through a pin hole or aperture 504 such that the selected mode beam 551 is incident on one or more downstream optical components (and/or a target location). The undesired or unselected mode beams 555 substantially do not pass through the pin hole or aperture 504 and are instead prevented from reaching the one or more downstream optical components (and/or the target location) by optical block 502.

For example, in various embodiments, the optical mode filter 500 further comprises an optical block 502 that defines, at least in part, a pinhole or aperture 504. For example, the pinhole or aperture 504 may be a through hole that extends through the optical block 502. In various embodiments, the optical block 502 is at least one of a photon absorber, a photon blocker, a photon deflector. For example, the optical block 502 is configured to prevent the passage of photons therethrough (other than through the pinhole or aperture 504).

In various embodiments, the optical mode filter 500 is further configured to condition the optical beam. For example, the optical mode filter 500 may act as a waveplate, lens, aspheric collimator, and/or the like. In various embodiments, an optical mode filter 500 is configured to control and/or condition optical properties of a respective optical beam (e.g., laser beam, series of laser pulses, microwave beam, and/or the like). For example, in an example embodiment, an optical mode filter 500 is configured to control and/or condition the polarization, wavelength, focusing, beam waist, wavelength, phase, direction of propagation, beam profile, intensity, and/or other optical property of an optical beam incident thereon.

FIG. 5 illustrates an incident optical beam 550 that is incident on the upstream surface 526 of a metasurface optical element 512 of an optical mode filter 500. The incident optical beam 550 is propagating generally and/or substantially parallel to an optical axis 508 of the optical mode filter 500. The metasurface optical element 512 (and any other optical elements of the optical mode filter 500) modify the propagation characteristics of modes of the optical beam(s) exiting the downstream surface 528 such that the modes may be spatially filtered (e.g., using a pin hole and/or aperture 504).

For example, the selected mode beam 551 is provided with first propagation characteristics. The first propagation characteristics correspond to the selected mode beam 551 being focused (e.g., via the metasurface optical element 512) such that a substantial portion of the selected mode beam 551 propagates through the pin hole or aperture 504 formed in the optical block 502. For example, the metasurface optical element 512 (or another focusing optical components of the optical mode filter 500) may focus the selected mode beam 551 at or in the pin holes or aperture 504. The selected mode beam 551 may pass through the pin hole or aperture 504 and be incident on one or more downstream optical components and/or a target location. Unselected mode beams 555 are provided with respective second propagation characteristics. The respective second propagation characteristics are configured such that the unselected mode beams 555 are not substantially focused at or into the pin hole or aperture 504 such that a substantial portion of the unselected mode beams 555 are incident on the optical block 502 and therefore prevented from reaching the downstream optical component(s) and/or the target location.

For example, the first propagation characteristics are configured such that a majority (e.g., 50% or more) of the optical power of the selected mode beam 551 is provided through the pin hole or aperture 504 to be incident on a downstream optical element or target location. The second propagation characteristics are configured such that a majority (e.g., 50% or more) of the optical power of the unselected mode beams 555 is incident on the optical block 502 and is not incident on the downstream optical element or target location.

FIG. 5 illustrates the pin hole or aperture 504 being aligned with the optical axis 508 of the optical mode filter 500. However, in various embodiments, the pin hole or aperture 504 is not aligned with the optical axis 508.

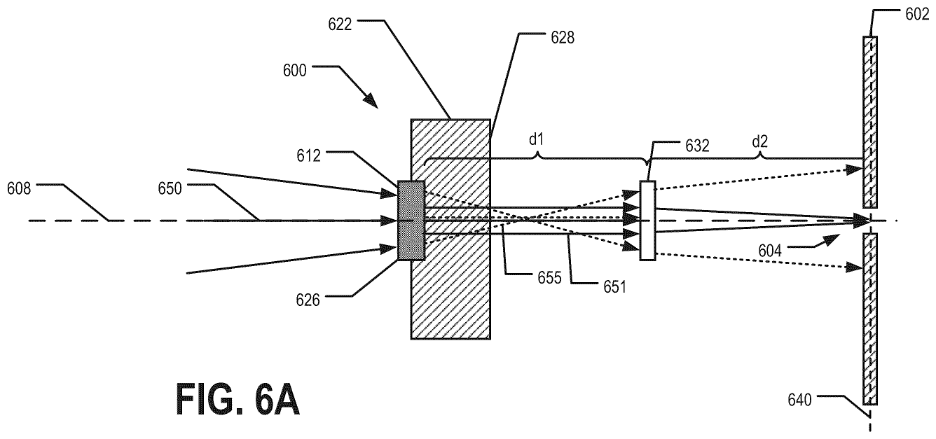

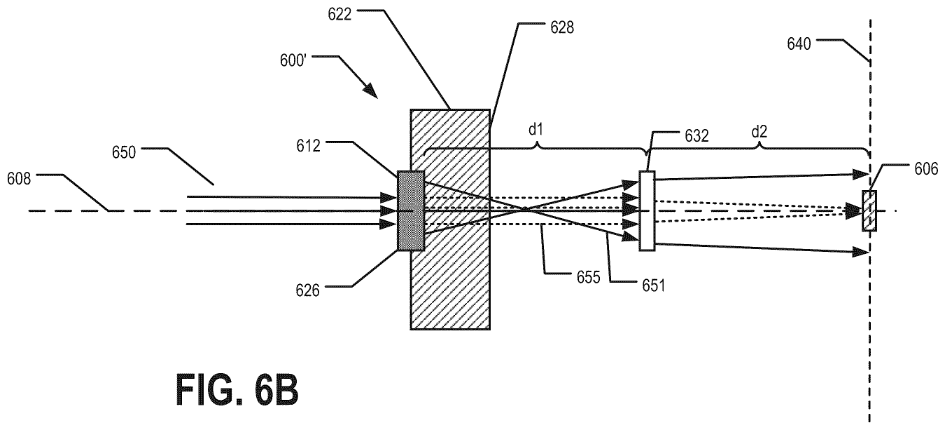

FIG. 6A illustrates another example optical mode filter 600 that may be used in an optical system 100, 300, 400. The optical mode filter 600 includes a metasurface optical element 612 formed on or in a substrate 622, a lens 632, and an optical block 602 having a pin hole or aperture 604 formed therethrough. For example, the optical block 602 is a partial beam block that filters light based on spatial location at the Fourier plane which corresponds to ray angle in real space. In various embodiments, the lens 632 is located a first distance d1 downstream from the metasurface optical element 612. In an example embodiment, the first distance d1 is the focal distance of the lens 632, such that the metasurface optical element 612 is located at a focal point of the lens 632. The optical block 602 is located at the Fourier plane 640 of the lens 632 a second distance d2 downstream of the lens 632. In an example embodiment, the second distance d2 is the focal length of the lens 632 and the pin hole or aperture 604 is located at a focal point of the lens 632. In various embodiments, the optical block 602 is at least one of a photon absorber, a photon blocker, a photon deflector. For example, the optical block 602 is configured to prevent the passage of photons therethrough (other than through the pinhole or aperture 604).

In various embodiments, the one or more optical mode filter 600 is configured to spatially separate optical modes of an optical beam incident thereon. For example, the optical mode filter 600 may be configured to affect the optical beam such that the selected mode beam 651 exits the downstream surface 628 of the substrate 622 having first propagation characteristics. The first propagation characteristics correspond, in an example embodiment, to the selected mode beam 651 being a substantially collimated beam between the metasurface optical element 612 and the lens 632. For example, the first propagation characteristics include a divergence angle that is less than a threshold angle. For example, the divergence angle of the selected mode beam 651 is less than a threshold angle (e.g., less than 15 degrees, less than 10 degrees, less than 5 degrees, less than 2 degrees, and/or the like). In the illustrated embodiment, the divergence angle of the selected mode beam 651 is zero.

The collimated selected mode beam 651 is incident on the lens 632 and is projected onto the Fourier plane 640, by the lens 632, such that a substantial portion of the selected mode beam 651 is propagated through the pin hole or aperture 604. For example, the first propagation characteristics are configured such that a majority (e.g., 50% or more) of the optical power of the selected mode beam 651 is provided through the pin hole or aperture 604 to be incident on a downstream optical element or target location.

The unselected mode beams 655 have respective second propagation characteristics that correspond to the unselected mode beams being divergent beams between the metasurface optical element 612 and the lens 632. For example, the respective second propagation characteristics include respective divergence angles that are larger than a threshold angle. For example, the divergence angles of the unselected mode beams 655 are larger than the threshold angle (e.g., greater than 5 degrees, greater than 10 degrees, greater than 15 degrees, and/or the like). The diverging unselected mode beam 655 is incident on the lens and is projected onto the Fourier plane 640, by the lens 632, such that a substantial portion of the unselected mode beam 655 is incident on the optical block 602. The portion of the unselected mode beam 655 that is incident on the optical block 602 does not reach the downstream optical components of the optical system. For example, only a small portion of the unselected mode beam 655 propagates through the pin hole or aperture 604.

For example, only a small portion (e.g., less than 50% or less than 20%) of the optical power of the unselected mode beam 655 is incident on downstream optical components and/or a target location. However, as the selected mode beam 651 is collimated, a large portion (e.g., more than 40%, more than 50%, and/or the like) of the optical power of the selected mode beam 651 is incident on one or more downstream optical components and/or a target location.

In various embodiments, the optical mode filter 600 is further configured to condition the optical beam. For example, the optical mode filter 600 may act as a waveplate, lens, aspheric collimator, and/or the like. In various embodiments, an optical mode filter 600 is configured to control and/or condition optical properties of a respective optical beam (e.g., laser beam, series of laser pulses, microwave beam, and/or the like). For example, in an example embodiment, an optical mode filter 600 is configured to control and/or condition the polarization, wavelength, focusing, beam waist, wavelength, phase, direction of propagation, beam profile, intensity, and/or other optical property of an optical beam incident thereon.

FIG. 6A illustrates an incident optical beam 650 that is incident on the upstream surface 626 of a metasurface optical element 612 of an optical mode filter 600. The incident optical beam 650 is propagating generally and/or substantially parallel to an optical axis 608 of the optical mode filter 600. The metasurface optical element 612 (and any other optical elements of the optical mode filter 600) modify the propagation characteristics of modes of the optical beam(s) exiting the downstream surface 628 such that the modes may be spatially filtered. The selected mode beam 651 is caused to propagate in a substantially collimated manner between the metasurface optical element 612 and the lens 632 such that the lens 632 focuses a substantial portion of the selected mode beam 651 onto the pin hole or aperture 604 disposed in the Fourier plane 640. Thus, a substantial portion of the selected mode beam 651 propagates downstream of the optical mode filter 600 and is incident on one or more downstream optical components (e.g., the pair of negative lenses 332, 432 for the optical systems of FIGS. 3 and 4 or another downstream optical element) or the target location. For example, the metasurface optical element 612 (or another focusing optical components of the optical mode filter 600) may substantially collimate the selected mode beam 651 upstream of the lens 632. Unselected mode beams 655 are caused to have substantial divergence angles such that the when the unselected mode beams 655 interact with the lens 632, the lens 632 does not focus the unselected mode beams 655 onto the pin hole or aperture 604. Thus, a substantial portion of the optical power of the unselected mode beams 655 is prevented from propagating downstream by the optical block 602.

FIG. 6B illustrates another example optical mode filter 600′ that may be used in an optical system 100, 300, 400. The optical mode filter 600′ includes a metasurface optical element 612 formed on or in a substrate 622, a lens 632, and an optical block 606. In various embodiments, the lens 632 is located a first distance d1 downstream from the metasurface optical element 612. In an example embodiment, the first distance d1 is the focal distance of the lens 632, such that the metasurface optical element 612 is located at a focal point of the lens 632. The optical block 606 is located at the Fourier plane 640 of the lens 632 a second distance d2 downstream of the lens 632. In an example embodiment, the second distance d2 is the focal length of the lens 632 and the optical block 606 is located at a focal point of the lens 632. In various embodiments, the optical block 606 is at least one of a photon absorber, a photon blocker, a photon deflector. For example, the optical block 606 is configured to prevent the passage of photons therethrough. For example, the optical block 606 may be the opposite of a pin hole or aperture. In various embodiments, an additional lens is downstream of the optical block 606 and is configured to focus or collimate the selected mode beam incident thereon. For example, the additional lens may collimate the selected mode beam or focus the selected mode beam toward a downstream optical component and/or target location.

In various embodiments, the optical mode filter 600′ is configured to spatially separate optical modes of an optical beam incident thereon. For example, the optical mode filter 600′ may be configured to affect the optical beam such that the selected mode beam 651 exits the downstream surface 628 of the substrate 622 having first propagation characteristics. The first propagation characteristics correspond, in an example embodiment, to the selected mode beam 651 being a divergent beam when the selected mode beam 651 is incident on the lens 632. For example, the first propagation characteristics include a divergence angle that is greater than a threshold angle. For example, the divergence angle of the selected mode beam 651 is greater than a threshold angle (e.g., greater than 15 degrees, greater than 10 degrees, greater than 5 degrees, greater than 2 degrees, and/or the like).

The collimated selected mode beam 651 is incident on the lens 632 and is projected onto the Fourier plane 640, by the lens 632, such that a substantial portion of the selected mode beam 651 is propagated around the optical block 606. For example, the first propagation characteristics are configured such that a majority (e.g., 50% or more) of the optical power of the selected mode beam 651 is provided around the optical block 606 to be incident on a downstream optical element or target location. For example, the lens 632 does not focus the selected mode beam 651 onto the optical block 606 at the Fourier plane 640 as a result of the divergence of the selected mode beam 651 when the selected mode beam 651 is incident on the lens 632.

The unselected mode beams 655 have respective second propagation characteristics that correspond to the unselected mode beams being substantially collimated beams between the metasurface optical element 612 and the lens 632. For example, the respective second propagation characteristics include respective divergence angles that are less than a threshold angle. For example, the divergence angles of the unselected mode beams 655 are less than the threshold angle (e.g., less than 2 degrees, less than 5 degrees, less than 10 degrees, less than 15 degrees, and/or the like). The collimated unselected mode beams 655 are incident on the lens 632 and are projected onto the Fourier plane 640, by the lens 632, such that a substantial portion of the unselected mode beams 655 are incident on the optical block 606. For example, the lens 632 focuses the unselected mode beams 655 onto the optical block 606. The portion of the unselected mode beam 655 that is incident on the optical block 606 does not reach the downstream optical components of the optical system. For example, only a small portion of the unselected mode beam 655 propagates around the optical block 606.

For example, only a small portion (e.g., less than 50% or less than 20%) of the optical power of the unselected mode beam 655 is incident on downstream optical components and/or a target location. However, as most of the selected mode beam 651 is directed around the optical block 606, a large portion (e.g., more than 40%, more than 50%, and/or the like) of the optical power of the selected mode beam 651 is incident on one or more downstream optical components and/or a target location.

### Example Quantum Computing System Comprising an Optical System

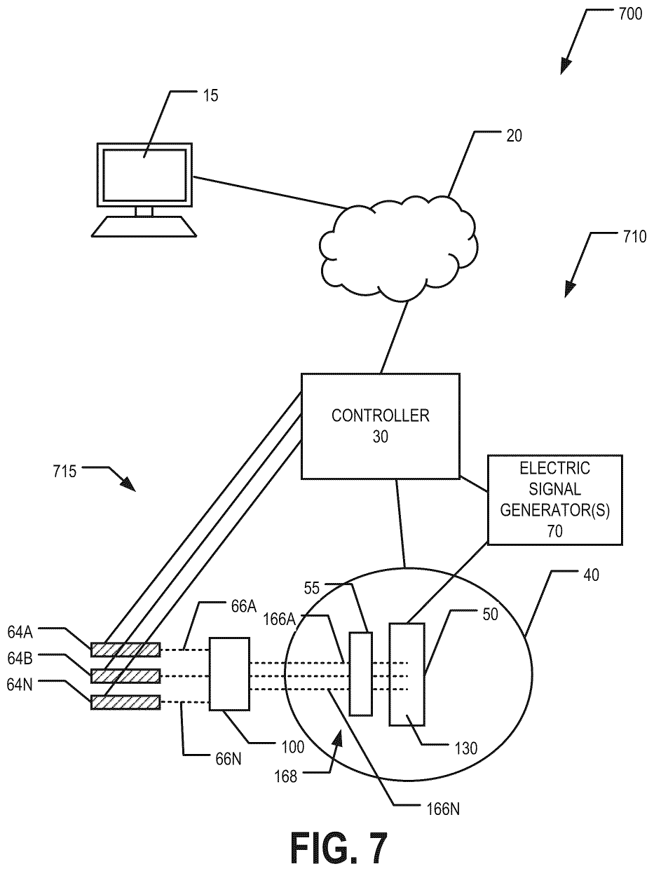

In various embodiments, an optical system 100, 300, 400 is part of a system. For example, the optical system 100, 300, 400 may be part of a system or assembly that includes one or more beam sources configured to generate and provide optical beams to the beam sources 110. For example, the optical system 100, 300, 400 may include an optical mode filter 200, 500, 600. For example, the optical system 100, 300, 400 may be part of a system or assembly that includes a target apparatus 130 that defines, at least in part, one or more target locations 134. In various embodiments, the optical system 100, 300, 400 is configured to condition and/or control respective optical properties of one or more optical beams and provide the respective optical beams to respective target locations 134. In various embodiments, conditioning and/or controlling respective optical properties of the one or more optical beams includes filtering the optical mode of the optical beam so that only one or more desired optical modes of the optical beam are provided to the respective target locations 134. An example of such a system that may include an optical system 100, 300, 400 is a quantum charge-coupled device (QCCD)-based quantum computing system 700, as illustrated by FIG. 7.

FIG. 7 provides a schematic diagram of an example quantum computing system 700 comprising an optical system 100, in accordance with an example embodiment. In various embodiments, the optical system 100 comprises optical beam sources 110, an optical mode filters 112, and a target apparatus 130. The example quantum computing system 700 further includes a plurality of manipulation sources 64 (e.g., 64A, 64B, . . . , 64N). The plurality of manipulation sources 64 are configured to generate respective optical beams 66 (e.g., 66A, 66B, . . . , 66N) that are provided (e.g., via free space optics, waveguides, optical fibers, and/or the like) to the beam sources 110. The example quantum computing system 700 further includes a quantum object confinement apparatus 50 that is a target apparatus 130. For example, the quantum object confinement apparatus 50 defines, at least in part, one or more target locations 134. The optical system 100 provides an array of property-controlled optical beams 168 that have respective optical properties that have been controlled and/or conditioned (e.g., via the respective optical mode filter 112) to respective target locations 134. For example, a respective optical beam 166 (e.g., 166A, . . . , 166N) have respective optical properties that have been controlled and/or conditioned by a respective optical mode filter is provided such that the respective optical beam 166 is incident on a respective target location 134. In various embodiments, the respective optical beam 166 has been filtered using an optical mode filter 112 such that the respective optical beam 166 only includes one or more desired optical modes.

In various embodiments, the quantum computing system 700 comprises a computing entity 10 and a quantum computer 710. In various embodiments, the quantum computer 710 comprises a controller 30 and a quantum processor 715. In various embodiments, the quantum processor 715 comprises a cryogenic and/or vacuum chamber 40, quantum object confinement apparatus 50 disposed within the cryogenic and/or vacuum chamber 40, one or more manipulation sources 64, an optical system 100, and one or more electric signal generators 70 configured to provide voltage and/or electrical signals to the electrical components (e.g., electrodes) of the quantum object confinement apparatus 50 to cause the quantum object confinement apparatus 50 to generate a confining potential and/or to electrical components of any active optical elements of the optical system 100. The quantum object confinement apparatus 50 acts as a target apparatus 130 and defines, at least in part, a plurality of target locations 134. In various embodiments the quantum processor 715 further includes one or more photodetectors configured for detecting optical signals generated by quantum objects confined at respective locations of the confinement apparatus 50, magnetic field generators configured to for generating a desired magnetic field and/or magnetic field gradient at respective target locations, calibration and/or feedback loop sensors, and/or the like.

In various embodiments, the cryogenic and/or vacuum chamber 40 is a temperature and/or pressure-controlled chamber. For example, the quantum computing system 700 may comprise vacuum and/or temperature control components that are operatively coupled to the cryogenic and/or vacuum chamber 40.

In various embodiments, the quantum computer 710 comprises one or more electric signal generators 70. For example, the electric signal generators 70 may comprise a plurality of voltage drivers and/or voltage sources and/or at least one radio frequency (RF) driver and/or voltage source. The electric signal generators 70 may be electrically coupled to the corresponding electrical components (e.g., electrodes) of the quantum object confinement apparatus 50, in an example embodiment. For example, the electric and/or electromagnetic field formed at least in part by applying the voltage and/or electrical signals generated by the electric signal generators 70 to the electrical components of the quantum object confinement apparatus 50 causes and/or forms the confinement region(s) of the confinement apparatus.

In various embodiments, a computing entity 10 is configured to allow a user to provide input to the quantum computer 710 (e.g., via a user interface of the computing entity 10) and receive, view, and/or the like output from the quantum computer 710. The computing entity 10 may be in communication with the controller 30 of the quantum computer 710 via one or more wired or wireless networks 20 and/or via direct wired and/or wireless communications. In an example embodiment, the computing entity 10 may translate, configure, format, and/or the like information/data, quantum computing algorithms and/or circuits, and/or the like into a computing language, executable instructions, command sets, and/or the like that the controller 30 can understand and/or implement.

In various embodiments, the controller 30 is configured to control and/or be in electrical communication with the electric signal generators 70, cryogenic system and/or vacuum system controlling the temperature and/or pressure within the cryogenic and/or vacuum chamber 40, manipulation sources 64, photodetectors, calibration and/or feedback loop sensors, any active optical elements of the optical system 100, and/or other systems controlling various environmental conditions (e.g., temperature, pressure, magnetic field, and/or the like) within the cryogenic and/or vacuum chamber 40 and/or configured to manipulate and/or cause a controlled evolution of quantum states of one or more quantum objects confined by the quantum object confinement apparatus 50. For example, the controller 30 may cause a controlled evolution of quantum states of one or more quantum objects within the confinement apparatus to execute a quantum circuit and/or algorithm. For example, the controller 30 may cause a reading procedure to be performed, possibly as part of executing a quantum circuit and/or algorithm. In various embodiments, the quantum objects confined within the confinement apparatus are used as qubits of the quantum processor 715 and/or quantum computer 710.

### Technical Advantages

In various optical systems, multiple optical modes may propagate through various portions of the optical system. The optical system may be configured to provide one or more optical beams or pulses for a particular interaction. For example, the optical system may be configured to provide optical beams or pulses (e.g., laser beams or pulses) for interaction with one or more particles (e.g., atoms, ions, molecules, quantum dots, and/or the like). The desired interaction may be performed with a beam of a particular beam profile. For example, it may be desired to have a first order Gaussian beam. In another example, it may be desired to have a higher order beam. Therefore, it may be desired to provide an optical beam or pulses having a particular optical mode. Thus, technical problems exist regarding how to filter an optical beam to provide an optical beam having only a desired optical mode and/or to remove undesired optical modes from the optical beam. To provide an optical beam of the desired beam profile or optical mode, the other optical modes.

Various embodiments provide technical solutions to these technical problems. In various embodiments, an optical mode filter and/or an optical system including an optical mode filter is provided. In various embodiments, the optical mode filter includes a metasurface optical element configured to spatially separate optical modes of an optical beam incident thereon. As the different optical modes of the optical beam are spatially separated by the optical mode filter, one or more desired optical modes may be guided downstream through the optical system and undesired optical modes can be removed from the optical beam. The desired optical mode may be guided to a target location to, for example, interact with one or more particles. Thus, various embodiments provide technical improvements to the fields of optical mode filtering, optical systems such as optical beam delivery systems, systems that include optical systems, and/or the like.

### Example Controller

In various embodiments, an optical system 100, 300, 400 comprising an optical mode filter 200, 500, 600 is incorporated into a system (e.g., a quantum computing system 700) comprising a controller 30. In various embodiments, the controller 30 is configured to control various elements of the system (e.g., quantum processor 715). For example, the controller 30 may be configured to control the electric signal generators 70, a cryogenic system and/or vacuum system controlling the temperature and pressure within the cryogenic and/or vacuum chamber 40, manipulation sources 64, cooling system, any active optical elements of the optical system, and/or other systems controlling the environmental conditions (e.g., temperature, humidity, pressure, and/or the like) within the cryogenic and/or vacuum chamber 40 and/or configured to manipulate and/or cause a controlled evolution of quantum states of one or more quantum objects confined by the quantum object confinement apparatus 50 (e.g., the target apparatus 130 with respect to the optical system 100). In various embodiments, the controller 30 may be configured to receive signals from one or more photodetectors, calibration and/or feedback loop sensors, and/or the like.

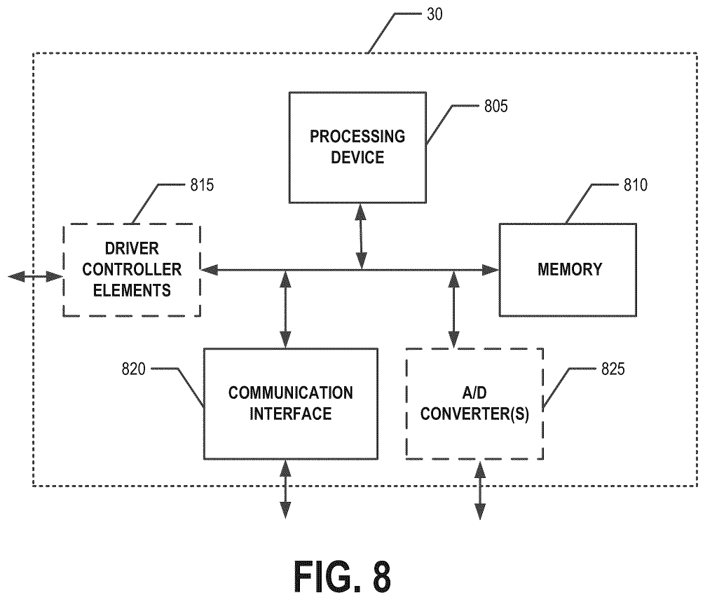

As shown in FIG. 8, in various embodiments, the controller 30 may comprise various controller elements including processing device 805, memory 810, driver controller elements 815, a communication interface 820, analog-digital (A/D) converter elements 825, and/or the like. For example, the processing device 805 may comprise one or more processing elements such as programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like, and/or controllers. The term circuitry may refer to an entirely hardware embodiment or a combination of hardware and computer program products. In an example embodiment, the processing device 805 of the controller 30 comprises a clock and/or is in communication with a clock.

For example, the memory 810 may comprise non-transitory memory such as volatile and/or non-volatile memory storage such as one or more of as hard disks, ROM, PROM, EPROM, EEPROM, flash memory, MMCs, SD memory cards, Memory Sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 810 may store a queue of commands to be executed to cause a quantum algorithm and/or circuit to be executed (e.g., an executable queue), qubit records corresponding the qubits of quantum computer (e.g., in a qubit record data store, qubit record database, qubit record table, and/or the like), a calibration table, computer program code (e.g., in a one or more computer languages, specialized controller language(s), and/or the like), and/or the like. In an example embodiment, execution of at least a portion of the computer program code stored in the memory 810 (e.g., by a processing device 805) causes the controller 30 to perform one or more steps, operations, processes, procedures and/or the like described herein for providing manipulation signals and/or optical beams that have respective optical properties that have been controlled and/or conditioned by the optical system 100, 300, 400 to respective target locations 134 defined at least in part by the quantum object confinement apparatus 50 and/or collecting, detecting, capturing, and/or measuring indications of emitted signals emitted by quantum objects located at corresponding object locations of the quantum object confinement apparatus 50. In various embodiments, the computer program code stored in the memory 810 comprise quantum assembly (QASM) and/or quantum intermediate representation (QIR) code and/or machine code generated by compiling QASM and/QIR code.

In various embodiments, the driver controller elements 815 may include one or more drivers and/or controller elements each configured to control one or more drivers. In various embodiments, the driver controller elements 815 may comprise drivers and/or driver controllers. For example, the driver controllers may be configured to cause one or more corresponding drivers to be operated in accordance with executable instructions, commands, and/or the like scheduled and executed by the controller 30 (e.g., by the processing device 805). In various embodiments, the driver controller elements 815 may enable the controller 30 to operate electric signal generators 70, manipulation sources 64, cooling system, and/or the like. In various embodiments, the drivers may be laser drivers configured to operate one or manipulation sources 64 to generate manipulation signals; vacuum component drivers; cryogenic and/or vacuum system component drivers; cooling system drivers, and/or the like. In various embodiments, the controller 30 comprises means for communicating and/or receiving signals from one or more optical receiver components (e.g., photodetectors calibration and/or feedback loop sensors). For example, the controller 30 may comprise one or more analog-digital converter elements 825 configured to receive signals from one or more optical receiver components (e.g., a photodetector of the optics collection system), calibration and/or feedback loop sensors, and/or the like.

In various embodiments, the controller 30 may comprise a communication interface 820 for interfacing and/or communicating with a computing entity 10. For example, the controller 30 may comprise a communication interface 820 for receiving executable instructions, command sets, and/or the like from the computing entity 10 and providing output received from the quantum computer 710 (e.g., from an optical collection system) and/or the result of a processing the output to the computing entity 10. In various embodiments, the computing entity 10 and the controller 30 may communicate via a direct wired and/or wireless connection and/or via one or more wired and/or wireless networks 20.

### Example Computing Entity

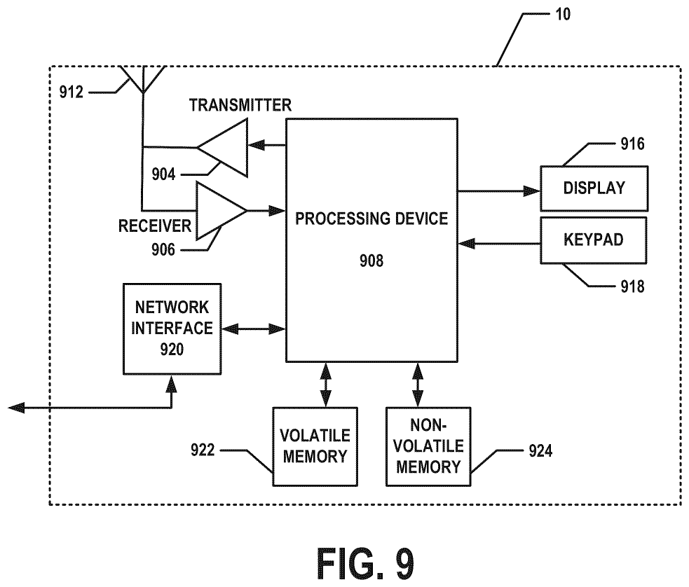

FIG. 9 provides an illustrative schematic representative of an example computing entity 10 that can be used in conjunction with embodiments of the present invention. In various embodiments, a computing entity 10 is configured to allow a user to provide input to the quantum computer 710 (e.g., via a user interface of the computing entity 10) and receive, display, analyze, and/or the like output from the quantum computer 710.

As shown in FIG. 9, a computing entity 10 can include an antenna 912, a transmitter 904 (e.g., radio), a receiver 906 (e.g., radio), and a processing element 908 that provides signals to and receives signals from the transmitter 904 and receiver 906, respectively. The signals provided to and received from the transmitter 904 and the receiver 906, respectively, may include signaling information/data in accordance with an air interface standard of applicable wireless systems to communicate with various entities, such as a controller 30, other computing entities 10, and/or the like. In this regard, the computing entity 10 may be capable of operating with one or more air interface standards, communication protocols, modulation types, and access types. For example, the computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system.

In various embodiments, the computing entity 10 may comprise a network interface 920 for interfacing and/or communicating with the controller 30, for example. For example, the computing entity 10 may comprise a network interface 920 for providing executable instructions, command sets, and/or the like for receipt by the controller 30 and/or receiving output and/or the result of a processing the output provided by the quantum computer 710. In various embodiments, the computing entity 10 and the controller 30 may communicate via a direct wired and/or wireless connection and/or via one or more wired and/or wireless networks 20.

The computing entity 10 may also comprise a user interface device comprising one or more user input/output interfaces (e.g., a display 916 and/or speaker/speaker driver coupled to a processing element 908 and a touch screen, keyboard, mouse, and/or microphone coupled to a processing element 908). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 918 (hard or soft), a touch display, voice/speech or motion interfaces, scanners, readers, or other input device. In embodiments including a keypad 918, the keypad 918 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like.

The computing entity 10 can also include volatile storage or memory 922 and/or non-volatile storage or memory 924, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

### CONCLUSION

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. An optical system comprising:
an optical mode filter comprising a metasurface optical element, wherein the metasurface optical element is configured to, in response to an optical beam being incident thereon, emit a selected mode beam with first propagation characteristics and one or more unselected mode beams with respective second propagation characteristics, wherein the first propagation characteristics differ from the respective second propagation characteristics such that a majority of optical power of the selected mode beam is caused to be incident on at least one of a downstream optical element or a target location and a majority of optical power of the one or more unselected mode beams is caused to be not incident on the at least one of the downstream optical element or the target location.

2. The optical system of claim 1, wherein differences in the first propagation characteristics and the second propagation characteristics are used to spatially filter the selected mode beam from the one or more unselected mode beams.

3. The optical system of claim 1 further comprising an optical block defining an aperture, wherein the first propagation characteristics are configured to cause the selected mode beam to propagate through the aperture and the second propagation characteristics are configured to cause the one or more unselected mode beams to be incident on the optical block.

4. The optical system of claim 3, wherein the first propagation characteristics corresponding focusing of the selected mode beam on the aperture.

5. The optical system of claim 1, further comprising:
a lens configured to project the selected mode beam and the one or more unselected mode beams onto a Fourier plane;
an optical block disposed at the Fourier plane, wherein the first propagation characteristics correspond to the selected mode beam propagating past the optical block and the second propagation characteristics corresponding to the one or more unselected mode beams being substantially incident on the optical block.

6. The optical system of claim 5, further comprising an additional lens downstream of the optical block configured to modify the first propagation characteristics of the selected mode beam.

7. The optical system of claim 1, wherein the first propagation characteristics correspond to the selected mode beam propagating along a selected mode axis and the second propagation characteristics correspond to the one or more unselected mode beams propagating along respective unselected mode axes, the selected mode axis and the respective unselected mode axes forming different angles with respect to an optical axis of the metasurface optical element.

8. The optical system of claim 7, wherein one of a photon absorber, a photon blocker, a photon deflector, or a photodetector is aligned with at least one of the respective unselected mode axes.

9. The optical system of claim 7, wherein differences in a direction defined by the selected mode axis and respective directions defined by the respective unselected mode axes are used to spatially filter the selected mode beam from the one or more unselected mode beams.

10. The optical system of claim 1, wherein the metasurface optical element is configured to control one or more optical properties of the selected mode beam.

11. The optical system of claim 10, wherein the one or more optical properties include at least one of polarization, wavelength, focusing, beam waist, phase, beam profile, or intensity.

12. The optical system of claim 1, further comprising a beam source configured to generate and provide the optical beam.

13. The optical system of claim 12, wherein the beam source comprises at least one of an optical fiber, waveguide, or laser and the optical beam is a laser beam.

14. The optical system of claim 12, wherein the beam source is part of a one-dimensional or two-dimensional array of beam sources and the metasurface optical element is part of one-dimensional or two-dimensional array of metasurface optical elements.

15. The optical system of claim 1, wherein the optical beam comprises one or more Gaussian, Laguerre Gaussian, Hermite Gaussian, Bessel beam, or Airy beam optical modes.

16. The optical system of claim 1, wherein the selected mode beam is propagated to the target location and the one or more unselected mode beams are propagated to one or more respective locations that are not the target location.

17. The optical system of claim 1, wherein the metasurface optical element is configured to act on the selected mode beam with a first order interaction.

18. An optical system comprising:
an optical mode filter comprising a metasurface optical element, wherein the metasurface optical element is configured to, in response to an optical beam being incident thereon, emit a selected mode beam along a selected mode axis and emit one or more unselected mode beams along respective unselected mode axes, the selected mode axis and the respective unselected mode axes forming different angles with respect to an optical axis of the metasurface optical element.

19. A system comprising:
one or more beam sources;
a target apparatus defining one or more target locations; and
an optical system comprising one or more optical mode filters each comprising a respective metasurface optical element, wherein the respective metasurface optical element is configured to, in response to an optical beam being incident thereon, emit a selected mode beam with first propagation characteristics and one or more unselected mode beams with respective second propagation characteristics, wherein the first propagation characteristics differ from the respective second propagation characteristics such that a majority of optical power of the selected mode beam is caused to be incident on at least one of a downstream optical element or a target location and a majority of optical power of the one or more unselected mode beams is caused to be not incident on the at least one of the downstream optical element or the target location,
wherein the one or more beam sources are configured to provide respective optical beams to the one or more optical mode filters and the selected mode beam is provided to a respective target location of the one or more target locations.

20. The system of claim 19, wherein the optical system is a beam delivery system configured to provide respective beams to the one or more target locations for performing particle interaction.
